(19) United States
(12) Patent Application Publication
(10) Pub. No.: US 2026/0177719 A1
(43) Pub. Date: Jun. 25, 2026

(54) SYSTEM AND METHOD FOR SEISMIC INTERPRETATION USING ACTIVE LEARNING DEEP NEURAL NETWORKS

(71) Applicant: Chevron U.S.A. Inc., San Ramon, CA (US)

(72) Inventors: Bruce Andrew Power, Houston, TX (US); Adam Dean Halpert, Houston, TX (US); Maisha Lara Amaru, Houston, TX (US); Anusha Sekar, Katy, TX (US)

(73) Assignee: Chevron U.S.A. Inc., San Ramon, CA (US)

(21) Appl. No.: 18/986,970

(22) Filed: Dec. 19, 2024

(51) Int. Cl. G01V 1/34

(52) U.S. Cl. CPC G01V 1/345; G01V 2210/6161; G01V 2210/70

(57) ABSTRACT

A method is described for automated seismic interpretation, including receiving a 3-D seismic image and a pre-trained neural network; selecting, from the 3-D seismic image, a sparse set of training data; and performing active learning to train an active learning model from the pre-trained neural network using the sparse set of training data. The active learning model is then used to predict a seismic interpretation for the 3-D seismic image. The method is executed by a computer system.

### TECHNICAL FIELD

The disclosed embodiments relate generally to techniques for automated interpretation of seismic images. In particular, the disclosed embodiments are related to automated seismic interpretation using active machine learning, including interpretation of stratigraphic or lithologic boundaries.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. Hydrocarbon deposits may exist in subsurface formations where they are trapped by either structural or stratigraphic features. Geological interpretation of seismic data is generally a manual process in which the interpreter makes interpretations of faults, geological/stratigraphic boundaries, and geobodies on a line-by-line basis. It is a difficult process to automate, as interpretation requires a highly specialized set of skills, and the seismic data has differences from typical RGB images upon which most computer vision networks are based. Current semi-automated methods are not able to accurately map horizon/surfaces/boundaries that are not a consistent phase single reflector.

The ability to define the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for automated methods of seismic interpretation.

### SUMMARY

In accordance with some embodiments, a method is disclosed for automated seismic interpretation including receiving, at one or more computer processors, a 3-D seismic image; receiving, at the one or more computer processors, a pre-trained neural network; selecting, from the 3-D seismic image, a sparse set of training data; performing, via the one or more computer processors, active learning to train an active learning model from the pre-trained neural network using the sparse set of training data; and storing, to non-transitory storage media, the active learning model. The active learning may include training the active learning model on less than 5% of the 3-D seismic image, performing an initial inference to create a prediction with errors, correcting errors in the prediction with errors to create a corrected prediction, re-assigning the corrected prediction as new training data, and repeating the active learning to train the active learning model. In an embodiment, the method may also apply the active learning model to the 3-D seismic image to generate a 3-D seismic interpretation. In another embodiment, anchor points are used to constrain the 3-D seismic interpretation. The anchor points may be from the training data and applied to the 3-D seismic image to constrain the 3-D seismic interpretation. The method may generate a graphical representation of the 3-D seismic interpretation; overlay the graphical representation of the 3-D seismic interpretation onto the 3-D seismic image; and display the graphical representation of the 3-D seismic interpretation overlayed onto the 3-D seismic image on a graphical display.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 demonstrates an example of a prior art method;

FIG. 2 illustrates an example system for automated seismic interpretation;

FIG. 3 illustrates an example workflow for automated seismic interpretation with active learning;

FIG. 4 compares two machine-learning architectures that may be used for automated seismic interpretation;

FIG. 5 illustrates a graphical user interface used for an example of a method for automated seismic interpretation with active learning; and

FIG. 6 illustrates an example of a result of a method for automated seismic interpretation with active learning compared with the correct “ground truth” interpretation.

Like reference numerals refer to corresponding parts throughout the drawings.

### DETAILED DESCRIPTION OF EMBODIMENTS

Described below are methods, systems, and computer readable storage media that provide a manner of automated seismic interpretation. These embodiments are designed to be of particular use for geologic segmentation of seismic images. These embodiments generate multi-dimensional maps of physical geobodies and/or horizons/surfaces/boundaries in the earth's subsurface, including those caused by different stratigraphy and/or lithology.

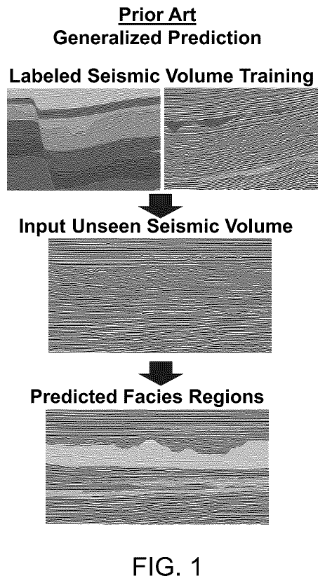

The present invention uses a deep learning neural network workflow that helps automate the interpretation process of conventionally-subjective geological objects and boundaries. Deep Learning segmentation is a rapidly advancing field that is now able to utilize convolutional neural networks to rapidly and accurately segment most objects in typical RGB images (photo images). An example of this is the Segment Anything deep neural network recently developed by Meta, which has been open-sourced. However, we cannot currently successfully apply these off-the-shelf networks for geological interpretation of seismic images, due to both the nature of seismic images, as well as derivative geological nature of the objects and boundaries (surfaces or horizons) that we wish to interpret from the images. Generalized computer vision prediction models that can achieve reliable classification/segmentation results require large amounts of accurate training data. This is very difficult in the case of geological seismic interpretation, where there is extreme variability of the subsurface images, both from the quality/resolution of the image and the underlying geology. Models created for one type of seismic interpretation in one part of the world can have little utility for other types of facies in other basins. Conventional machine-learning interpretation methods utilizing transformer base models may be effective for identifying faults and/or geobodies, but they do not perform well for detection and inference of horizons or surfaces representing the geological stratigraphic boundaries. These stratigraphic boundaries may be characterized by a single phase-consistent seismic reflection, or they may be characterized by an inferred surface composed of segments of multiple seismic reflectors of varying phase and amplitude. Seismic volume horizons are the mostly-continuous reflectors representative of boundaries between different geologic layers in the subsurface. An example of a conventional generalized prediction machine-learning interpretation method is shown in FIG. 1. Here, a large number of labeled seismic training pairs (called the labeled seismic volume training) are used to train a convolutional neural network (CNN). The CNN is applied to an input unseen seismic volume, resulting in the predicted facies region.

The present invention seeks to automate the interpretation of geological boundaries (horizons, surfaces, zonal boundaries) within seismic images using deep learning convolutional neural networks in which the human interpreter provides constraints and guidance to the training and inference networks through iteration. There are current products that accomplish this task for faults and salt body interpretation, but they do not apply their workflows to the interpretation of other types of geological objects, such as stratigraphic or lithological boundaries. In particular, current semi-automated methods are not able to accurately map horizon/surfaces/boundaries that are not a consistent phase single reflector.

The present invention uses an active learning-based deep neural network for the geological interpretation of seismic images. Active learning is a machine learning technique that uses a learning algorithm that can query a user to interactively label data. There is no pre-existing machine-learning (ML) encoder-decoder model. The model is generated solely from the interpreter-created training data that comes from within the desired prediction volume. This training data can be iteratively augmented by utilizing ML predictions from previously uninterpreted regions of the data volume and then re-running successive ML predictions if desired. Specifically, it is focused on the interpretation of lithological boundaries. This includes, but is not limited to, stratigraphic boundaries that do not follow a single seismic reflector, such as unconformities or facies boundaries where lithology changes. The method accomplishes this task using a combination of a pre-trained neural network along with sparse training data provided by the interpreter for the desired training and prediction seismic volume. A deep neural network machine learning model is generated based on the provided data. Geological constraints (anchor points based on training data from other seismic line directions) are provided by the interpreter that help guide and constrain the inference phase workflow of the neural network. This intermediate step allows for accurate prediction of geological objects that are only 1-2 pixels wide, such as boundaries or surfaces. Detecting the thin boundaries is done via a downsampled coarse mask prediction (part of a cropped U-net) and then post-processing skeletonization of the downsampled horizon prediction. The anchor points allow for a more accurate 3D prediction of a single horizon by restricting the prediction of the horizon to being between 2 anchor points. The ML model and inference is done in 2D, and the anchor points allow for some 2.5D spatial context to the inference step. The use of anchor points during the inference and this method's ability to allow for prediction of thin boundaries differentiates this workflow from other approaches.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

The methods and systems of the present disclosure may, in part, use one or more models that are machine-learning algorithms. These models may be supervised or unsupervised. Supervised learning algorithms are trained using labeled data (i.e., training data) which consist of input and output pairs. By way of example and not limitation, supervised learning algorithms may include classification and/or regression algorithms such as neural networks, generative adversarial networks, linear regression, etc. Unsupervised learning algorithms are trained using unlabeled data, meaning that training data pairs are not needed. By way of example and not limitation, unsupervised learning algorithms may include clustering and/or association algorithms such as k-means clustering, principal component analysis, singular value decomposition, etc. Although the present disclosure may name specific models, those of skill in the art will appreciate that any model that may accomplish the goal may be used. In an embodiment, the present method may use an active learning deep neural network.

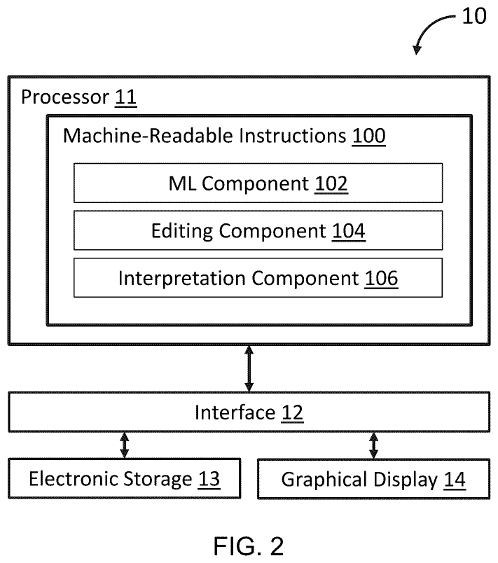

The methods and systems of the present disclosure may be implemented by a system and/or in a system, such as a system 10 shown in FIG. 2. The system 10 may include one or more of a processor 11, an interface 12 (e.g., bus, wireless interface), an electronic storage 13, a graphical display 14, and/or other components. The processor 11 will receive seismic images and a pre-trained CNN. The processor 11 will output seismic interpretations.

The electronic storage 13 may be configured to include any electronic storage medium that electronically stores information. The electronic storage 13 may store software algorithms, information determined by the processor 11, information received remotely, and/or other information that enables the system 10 to function properly. For example, the electronic storage 13 may store information relating to the seismic images, the CNN, machine-specified or user-specified edits, and/or other information. For example, the electronic storage 13 may store information relating to seismic interpretations, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 2 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to the multi-dimensional maps of the interpreted stratigraphic/lithologic boundaries and/or the intermediate steps of the active learning cycle, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate automated seismic interpretation. The machine-readable instructions 100 may include one or more computer program components. The machine-readable instructions 100 may include a machine-learning (ML) component 102, an editing component 104, an interpretation component 106, and/or other computer program components.

It should be appreciated that although computer program components are illustrated in FIG. 2 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

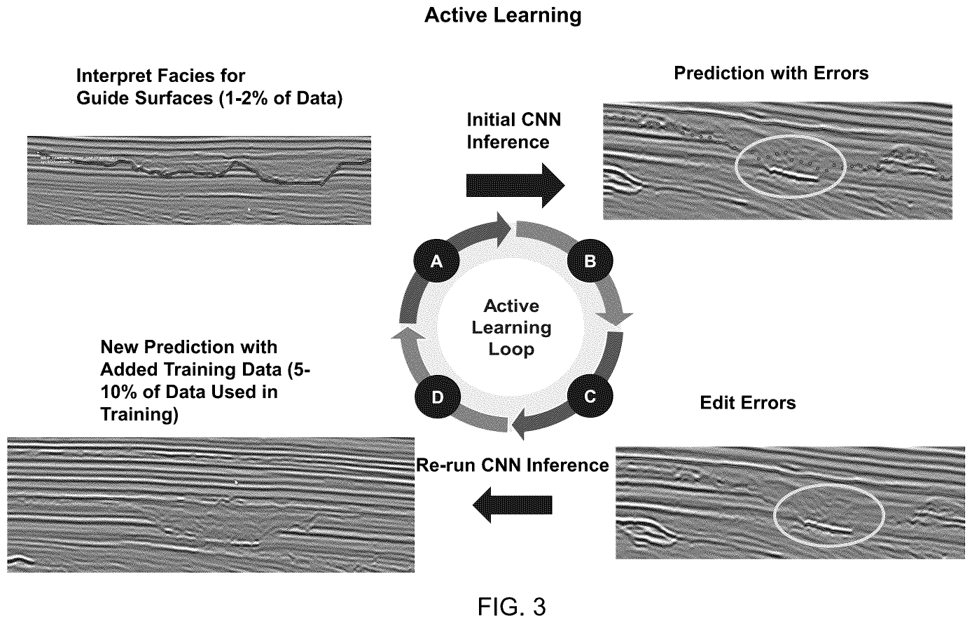

Referring again to machine-readable instructions 100, the machine-learning (ML) component 102 may be configured to perform an active learning cycle. ML component 102 will interact with editing component 104 to allow machine-specified or user-specified anchor points to be added during the active learning cycle. This is illustrated in FIG. 3. In FIG. 3 at step A, a pre-trained CNN and a sparse set of seismic images with user-interpreted features is received. In this example, this sparse set of seismic images is only 1-2% of the available seismic images. This process is sometimes called deep supervision for the neural network, wherein the central idea of Deeply-Supervised Nets is to provide direct supervision to the hidden layers, rather than providing supervision only at the output layer and subsequently propagating this supervision back to earlier layers. It is accomplished by providing companion objective functions for the individual hidden layers; the presence of these companion objective functions can be seen as an additional (soft) constraint (or as a new regularization) within the learning process. For sparse training data and relatively shallower networks, deep supervision functions as a strong “regularization” for classification accuracy and learned features and allows for gradual learning of deeper networks by improving otherwise problematic convergence behavior. In FIG. 3 at step B, the active learning cycle performs the initial CNN inference to create a prediction with errors. These errors are corrected using editing component 104, as shown in FIG. 3 step C, and then the corrected prediction is used as training data to create a new prediction (step D).

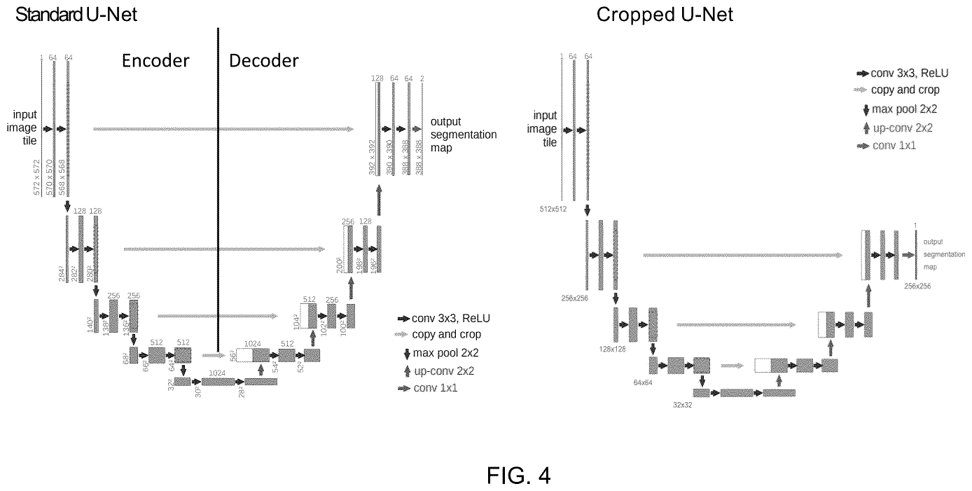

Embodiments of CNN architectures that may be used in the active learning cycle are shown in FIG. 4. For the standard U-Net on the left, the encoder leg gradually reduces the size of the image while learning image property correlations at different spatial distances (the “what” of the image). The decoder leg learns the special distribution of these properties (the “where” of the image). However, the unique problem of training a CNN for seismic interpretation of stratigraphic/lithologic boundaries would require far more training data than is available. Therefore, in an embodiment, the standard U-Net architecture may be modified by replacing the initial portions of the encoder with any existing classificational architecture, like ResNet or EfficientNet, using weights for this new encoder, pretrained on extremely large classification datasets, like ImageNet. This pre-trained CNN may be used as the initial CNN used in step A of FIG. 3. This allows the CNN to have pre-learned basic properties of image annotation and segmentation from other data and then the current invention can augment this encoder training with additional information from seismic images. This embodiment prevents overfitting of the model on a limited training dataset. With appropriate training data, model training and inference takes only a few hours.

Standard U-Net CNNs will have difficulty with the seismic interpretation of stratigraphic/lithologic boundaries due to the class imbalance of the problem. Specifically, very few pixels of the seismic images are associated with the horizons/boundaries compared to the pixels associated with “non-boundary” pixels. In an embodiment, the standard U-Net CNN may be replaced with a Cropped U-Net, as shown on the right of FIG. 4. For the Cropped U-Net CNN, the main idea is to predict downsampled segmentation masks instead of original ones. Not only will this decrease the class imbalance, it will limit the computational burden and improve and speed-up convergence. The predicted horizon is a skeletonized version of the inferred down-sampled prediction horizon.

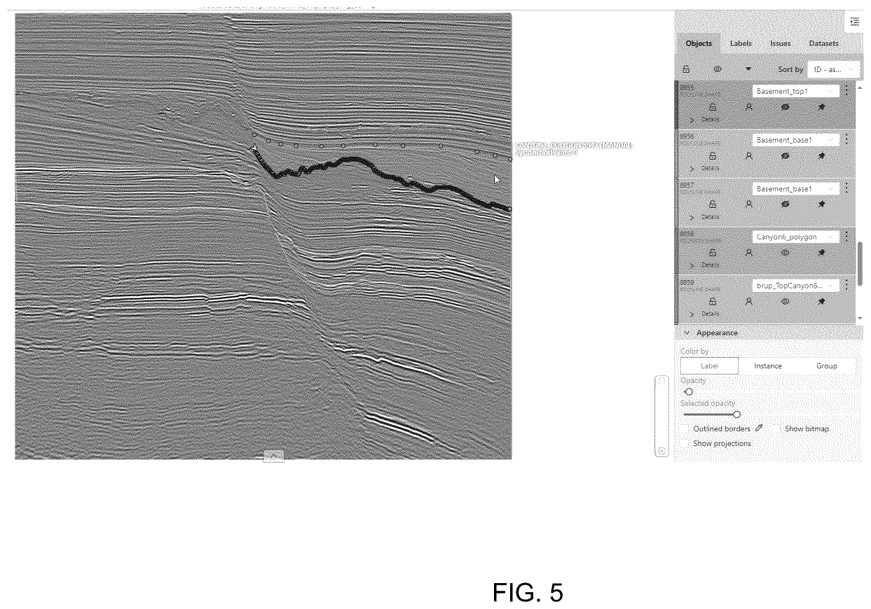

Referring again to FIG. 2, the interpretation component 106 may be configured to generate the multi-dimensional maps of the geological boundaries in the earth's subsurface based on the predictions from the active learning cycle performed by ML component 102 and editing component 104. Anchor points are used during the inference. The anchor points are the locations where training data lines (such as the inline lines) cross the seismic lines, such as the crosslines. The anchor points provide “guide points” or constraints on the seismic lines for inference. These multi-dimensional maps may be displayed on graphical display 14 and/or stored in electronic storage 13. FIG. 5 illustrates an example of a graphical display of the multi-dimensional maps overlaid on the seismic image. The same active learning cycle can interpret multiple horizons/geobodies, resulting in multiple multi-dimensional maps in the same graphical display, such as various colored lines representative of horizons and boundaries of geobodies, and the green fill region. Although the examples herein are focused on geologic boundaries, the method is also applicable to other features contained in seismic images, such as seismic mega-amplitude events.

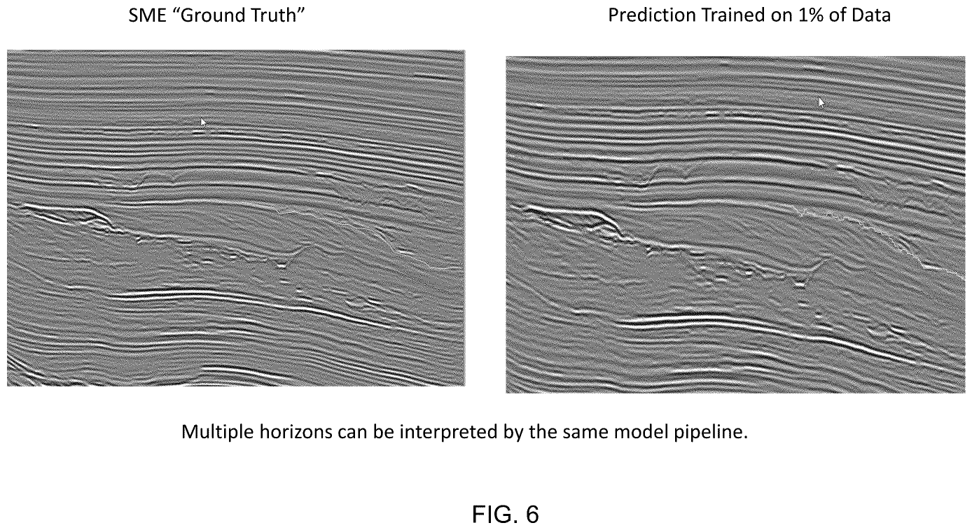

FIG. 6 compares a known “ground truth” model (left panel) with known boundaries with a result of the prediction of the present invention (right panel). The embodiment used for the result on the right only trained the CNN on 1% of the data available. Overall, the automated seismic interpretation predicted the boundaries very accurately and the computational cost and interpretation time was much lower than conventional methods.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The adaptive, dynamic nature and utilization of advanced architectures redefine the boundaries of computational capabilities. By design, machine learning architectures function outside of any preprogrammed routines. Thus, the training and/or analysis performed by machine learning architectures is not performed by predefined computer algorithms but rather improve the functioning of the computer system and extends well beyond mental processes and abstract ideas.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of automated seismic interpretation, comprising:
a. receiving, at one or more computer processors, a 3-D seismic image;
b. receiving, at the one or more computer processors, a pre-trained neural network;
c. selecting, from the 3-D seismic image, a sparse set of training data;
d. performing, via the one or more computer processors, active learning to train an active learning model from the pre-trained neural network using the sparse set of training data; and
e. storing, to non-transitory storage media, the active learning model.

2. The method of claim 1 wherein the active learning includes training the active learning model on less than 5% of the 3-D seismic image, performing an initial inference to create a prediction with errors, correcting errors in the prediction with errors to create a corrected prediction, re-assigning the corrected prediction as new training data, and repeating the active learning to train the active learning model.

3. The method of claim 1 further comprising applying the active learning model to the 3-D seismic image to generate a 3-D seismic interpretation.

4. The method of claim 3 wherein anchor points are used to constrain the 3-D seismic interpretation.

5. The method of claim 4 wherein the anchor points are from the training data and are applied to the 3-D seismic image to constrain the 3-D seismic interpretation.

6. The method of claim 3 further comprising generating a graphical representation of the 3-D seismic interpretation; overlaying the graphical representation of the 3-D seismic interpretation onto the 3-D seismic image; and displaying the graphical representation of the 3-D seismic interpretation overlayed onto the 3-D seismic image on a graphical display.

7. The method of claim 1 wherein the active learning model is a Cropped U-Net convolutional neural network.

8. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive, at the one or more processors, a 3-D seismic image;
b. receive, at the one or more processors, a pre-trained neural network;
c. select, from the 3-D seismic image, a sparse set of training data;
d. perform, via the one or more processors, active learning to train an active learning model from the pre-trained neural network using the sparse set of training data; and
e. store, to non-transitory storage media, the active learning model.

9. The computer system of claim 8 wherein the active learning includes training the active learning model on less than 5% of the 3-D seismic image, performing an initial inference to create a prediction with errors, correcting errors in the prediction with errors to create a corrected prediction, re-assigning the corrected prediction as new training data, and repeating the active learning to train the active learning model.

10. The computer system of claim 8 further comprising applying the active learning model to the 3-D seismic image to generate a 3-D seismic interpretation.

11. The computer system of claim 10 wherein anchor points are used to constrain the 3-D seismic interpretation.

12. The computer system of claim 11 wherein the anchor points are from the training data and are applied to the 3-D seismic image to constrain the 3-D seismic interpretation.

13. The computer system of claim 10 further comprising generating a graphical representation of the 3-D seismic interpretation; overlaying the graphical representation of the 3-D seismic interpretation onto the 3-D seismic image; and displaying the graphical representation of the 3-D seismic interpretation overlayed onto the 3-D seismic image on a graphical display.

14. The computer system of claim 8 wherein the active learning model is a Cropped U-Net convolutional neural network.

15. A non-transitory computer readable storage medium storing one or more programs, the one or more programs comprising instructions, which when executed by an electronic device with one or more processors and memory, cause the device to perform the method of claim 1.
